(19) United States
(12) Patent Application Publication
(10) Pub. No.: US 2026/0103080 A1
(43) Pub. Date: Apr. 16, 2026

(54) POWER SUPPLY CONTROLLER AND VEHICLE

(71) Applicant: TOYOTA JIDOSHA KABUSHIKI KAISHA, Toyota-shi (CA)

(72) Inventor: Misako SHIGYO, Okazaki-shi (JP)

(73) Assignee: TOYOTA JIDOSHA KABUSHIKI KAISHA, Toyota-shi (JP)

(21) Appl. No.: 19/322,016

(22) Filed: Sep. 8, 2025

(30) Foreign Application Priority Data
Oct. 11, 2024 (JP) 2024-178795

(51) Int. Cl. B60L 1/00; B60L 53/16

(52) U.S. Cl. CPC B60L 1/006; B60L 53/16; B60L 2210/40

(57) ABSTRACT

A vehicle having a battery mounted thereon externally supplies power. The vehicle is provided with an ECU, which sets a power supply voltage VP and a maximum current MP based on a potential of a PISW signal. Furthermore, when the ECU receives a PWM signal (a CPLT signal), the ECU sets a power supply voltage VC and a maximum current MC based on the PWM signal. When the power supply voltage VP is set and the power supply voltage VC is also set, the ECU sets the lower one of the power supply voltages VP and VC for a discharging voltage VO and sets the smaller one of the maximum currents MP and MP for a discharging current MO. The ECU controls an AC inverter so that the vehicle discharges power with the discharging voltage VO and the discharging current MO, and the ECU thus starts supplying power.

### CROSS REFERENCE TO RELATED APPLICATIONS

This nonprovisional application is based on Japanese Patent Application No. 2024-178795 filed on Oct. 11, 2024 with the Japan Patent Office, the entire contents of which are hereby incorporated by reference.

### BACKGROUND

### Field

The present disclosure relates to a power supply controller and a vehicle.

### Description of the Background Art

Japanese Patent Laying-Open No. 2015-012697 discloses a technique for detecting a type of a connector connected to an inlet of an electric vehicle. This technique uses a signal (a proximity detection signal) for detecting whether a connector is connected to an inlet to determine whether the connector is a charging connector or a discharging connector. When it is determined that the discharging connector is connected, whether the connector is a power extraction connector or an equipment connector is determined using a signal (a control pilot (CPLT) signal) conventionally used to control charging power. Hereinafter, the proximity detection signal will also be referred to as a PISW signal.

When an external load is powered from a vehicle, the CPLT signal or the PISW signal is used to communicate a connected state of a discharging connector, a power supply voltage, a power supply current, and other information between the vehicle and power supply equipment. For example, “SAE 2847/5”, a standard of the Society of Automotive Engineers, defines a power supply system using the PISW signal and the CPLT signal.

A power supply system using the PISW signal for example refers to the potential of the PISW signal to set a power supply voltage and a power supply current (a maximum current) that the power supply equipment requires. The CPLT signal is a pulse width modulation (PWM) signal used in communications between the vehicle and the power supply equipment. A power supply system using the CPLT signal uses PWM's duty ratio and frequency to set a power supply voltage and a power supply current that the power supply equipment requires.

The power supply equipment uses one of the PISW signal and the CPLT signal to transmit information of a power supply voltage and/or the like that the power supply equipment requires to the vehicle. However, if there is “power supply equipment which uses both the PISW signal and the CPLT signal to transmit information of a power supply voltage and/or the like to a vehicle, the power supply voltage or the like based on the PISW signal and the power supply voltage or the like based on the CPLT signal may be different. Therefore, there is a possibility that an overvoltage or an overcurrent may be generated in power supplied from the vehicle. For this reason, supplying power to “power supply equipment which uses a plurality of signals to transmit information of a power supply voltage and/or the like to a vehicle” may be avoided.

### SUMMARY

An object of the present disclosure is to supply power to “power supply equipment which uses a plurality of signals to transmit information of a power supply voltage and/or the like to a vehicle”without generating overvoltage or the like.

According to the present disclosure a power supply controller causes a vehicle to externally supply power, the vehicle having at least one of a power storage device and a power generation device mounted thereon. When a discharging connector is connected to a discharging port of the vehicle, and a first signal is received through a first terminal of the discharging port, the power supply controller is configured to apply a first power supply voltage based on the first signal to start supplying power. Furthermore, when the discharging connector is connected to the discharging port of the vehicle, and a second signal is received through a second terminal (CPLT) of the discharging port, the power supply controller is configured to apply a second power supply voltage based on the second signal to start supplying power. When the first and second signals are both received, the power supply controller is configured to apply a lower one of the first and second power supply voltages to cause the vehicle to externally supply power.

According to this configuration, when a discharging connector is connected to a discharging port of a vehicle and a first signal is received through a first terminal of the discharging port, a power supply controller applies a first power supply voltage based on the first signal to start supplying power. When the discharging connector is connected to the discharging port and a second signal is received through a second terminal of the discharging port, the power supply controller applies a second power supply voltage based on the second signal to start supplying power. When the first and second signals are both received, the power supply controller applies the lower one of the first and second power supply voltages to cause the vehicle to externally supply power. Thus, even when the first and second signals are both received, the power supply controller applies the lower voltage to supply power, and can thus supply power to “power supply equipment which uses a plurality of signals to transmit information of a power supply voltage or the like to a vehicle” without generating overvoltage. Note that when the first signal is alone received, the power supply controller applies the first power supply voltage to supply power.

The first signal may include information of a first maximum current, and the second signal may include information of a second maximum current. When the first and second signals are both received, the power supply controller may further be configured to apply a smaller one of the first and second maximum currents to cause the vehicle to externally supply power.

According to this configuration, when the first and second signals are both received, that is, for “power supply equipment which uses a plurality of signals to transmit information of a power supply voltage and/or the like to a vehicle”, the power supply controller applies the smaller one of the first and second maximum currents to cause the vehicle to externally supply power. This allows the vehicle to supply power while suppressing generation of overcurrent.

When the discharging connector is connected to the discharging port the first terminal may form a closed circuit with a resistance circuit provided on the side of the discharging connector. The first signal may be a potential signal coming from the resistance circuit, and the second signal may be a PWM signal transmitted from the side of the discharging connector.

According to this configuration, the first signal is a potential signal (a PISW signal) coming from a resistance circuit provided on the side of the discharging connector. The second signal is a PWM signal (a CPLT signal) transmitted from the side of the discharging connector. Therefore, even when power supply equipment is “power supply equipment which uses both the PISW signal and the CPLT signal to transmit information of a power supply voltage and/or the like to a vehicle”, supplying power can be done without generating overvoltage or the like.

When the discharging connector is connected to the discharging port the first signal may decrease in potential, and the power supply controller may detect from the potential of the first signal that the discharging connector is connected to the discharging port.

According to this configuration, the fact that the discharging connector is connected to the discharging port can be detected through the first signal.

According to the present disclosure, a vehicle has at least one of a power storage device and a power generation device mounted thereon, and comprises a discharging port. The vehicle comprises a discharging device provided between the discharging port and at least one of the power storage device and the power generation device, and a controller configured to control the discharging device. When a discharging connector is connected to the discharging port, and a first signal received through a first terminal of the discharging port indicates a voltage, the controller is configured to set a first power supply voltage based on the first signal, whereas when the discharging connector is connected to the discharging port, and a second signal is received through a second terminal of the discharging port, the controller is configured to set a second power supply voltage based on the second signal. When the first power supply voltage is set and the second power supply voltage is also set, the controller is configured to control the discharging device so that the discharging device applies a lower one of the first and second power supply voltages to start discharging power from the discharging device.

According to this configuration, the discharging device supplies (or discharges) power of at least one of the power storage device and the power generation device outside the vehicle. For example, when the discharging device includes a power conversion device that converts DC power of the power storage device or the power generation device to AC power, the AC power can be supplied outside the vehicle.

When a first signal received through a first terminal of the discharging port indicates a voltage, the controller is configured to set a first power supply voltage based on the first signal, and whereas when a second signal is received through a second terminal of the discharging port, the controller is configured to set a second power supply voltage based on the second signal. Then, when the first power supply voltage is set and the second power supply voltage is also set, the lower one of the first and second power supply voltages is applied to discharge power through the discharging device. Thus, even when the first and second power supply voltages are set, the vehicle supplies power by the lower voltage and can thus supply power to “power supply equipment which uses a plurality of signals to transmit information of a power supply voltage and/or the like to a vehicle”without generating overvoltage.

The first signal may include information of a first maximum current, and the second signal may include information of a second maximum current. When the first power supply voltage is set and the second power supply voltage is also set, the controller is configured to control the discharging device so that the discharging device applies a smaller one of the first and second maximum currents to start discharging power from the discharging device.

According to this configuration, when the first power supply voltage is set and the second power supply voltage is also set, that is, for “power supply equipment which uses a plurality of signals to transmit information of a power supply voltage and/or the like to a vehicle”, the controller applies the smaller one of the first and second maximum currents to discharge power through the discharging device. This can suppress generation of overcurrent.

The discharging device may convert DC power of the power storage device or the power generation device to AC power.

According to this configuration, the vehicle can externally supply AC power.

These and other objects, features, aspects and advantages of the present disclosure will become apparent from the following detailed description taken in conjunction with the accompanying drawings.

### BRIEF DESCRIPTION OF THE DRAWINGS

FIG. 1 generally, schematically shows a configuration of a power supply system according to an embodiment.

FIG. 2 shows a configuration around a charging/discharging device.

FIG. 3 shows an external appearance of a discharging connector.

FIG. 4 shows a schematic circuit configuration of the discharging connector and an inlet in a power supply system using a PISW signal.

FIG. 5 is timing plots representing a sequence of starting and stopping discharging power by the discharging connector in the power supply system using the PISW signal.

FIG. 6 shows a schematic circuit configuration of the discharging connector and the inlet in a power supply system using a CPLT signal.

FIG. 7 shows a schematic circuit configuration of a third discharging connector and an inlet.

FIG. 8 is a flowchart of an example of a process performed by an ECU to start discharging power.

FIG. 9 shows a modification of a discharging assembly (the discharging connector).

### DESCRIPTION OF THE PREFERRED EMBODIMENTS

Hereinafter, embodiments of the present disclosure will be described in detail with reference to the drawings. In the figures, identical or equivalent components are identically denoted and will not be described repeatedly. Hereinafter, an electronic control unit will be referred to as an “ECU”. Furthermore, an alternating current may be referred to as “AC”, and a direct current may be referred to as “DC”.

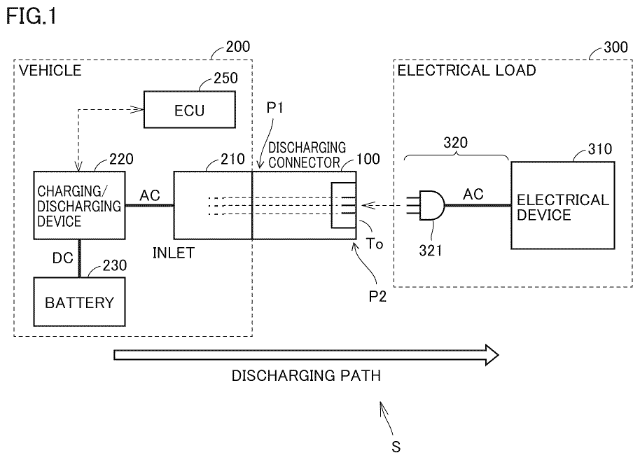

FIG. 1 generally, schematically shows a configuration of a power supply system according to an embodiment. A power supply system S according to the present embodiment is applied to V2L (Vehicle to Load) allowing a vehicle to directly power an electrical device. V2L employs a power converter mounted for a vehicle (e.g., an in-vehicle inverter) to power an electrical device. The in-vehicle inverter is a device that converts DC power of a driving in-vehicle battery to AC power and supplies the AC power to the electrical device.

Referring to FIG. 1, power supply system S includes a discharging connector 100 and a vehicle 200 and is configured to receive power from vehicle 200 and supply the received power to an electrical load (or an external load) 300 through discharging connector 100. In the present embodiment, discharging connector 100 includes a first end P1 and a second end P2 and functions as a discharging assembly. The discharging assembly is power supply equipment that receives power from vehicle 200 and supplies the received power to electrical load 300. Vehicle 200 may be any vehicle having a discharging function, and while a BEV (battery electric vehicle) comprising no engine (internal combustion engine) is adopted as vehicle 200 in the present embodiment, the vehicle may be a PHEV (plug-in hybrid electric vehicle) comprising an engine.

Electrical load 300 comprises an electrical device 310 (a device body) and a power cord 320 connected to electrical device 310. Electrical device 310 is driven when it receives prescribed AC power supplied through power cord 320. Discharging connector 100 includes a socket To to which a plug 321 of power cord 320 is connectable.

Vehicle 200 comprises an inlet 210 (a vehicular inlet), a charging/discharging device 220, a battery 230, and an ECU 250. Inlet 210 and battery 230 correspond to an example of a “discharging port” and a “power storage device”, respectively, according to the present disclosure. Inlet 210 corresponds to a portion of power supply system S which is fixed in vehicle 200. Battery 230 for example includes a secondary battery. The secondary battery may be a lithium ion battery or a nickel metal hydride battery. Battery 230 may be an electric double layer capacitor. Vehicle 200 is configured to be capable of travelling using power stored in battery 230. Vehicle 200 comprises an electric motor that receives power supplied from battery 230, and the vehicle travels by driving force generated by the electric motor.

Charging/discharging device 220 is configured to electrically charge battery 230. Charging/discharging device 220 is configured to receive AC power supplied from outside the vehicle to inlet 210, convert the received AC power to DC power (or perform AC/DC conversion), and output the DC power to battery 230. Charging/discharging device 220 is also configured to discharge power of battery 230 to outside the vehicle. In the present disclosure, discharging power of battery 230 outside the vehicle is also referred to as “supplying power”. Charging/discharging device 220 is configured to receive DC power supplied from battery 230, convert the received DC power to AC power (or perform DC/AC conversion), and output the AC power to inlet 210.

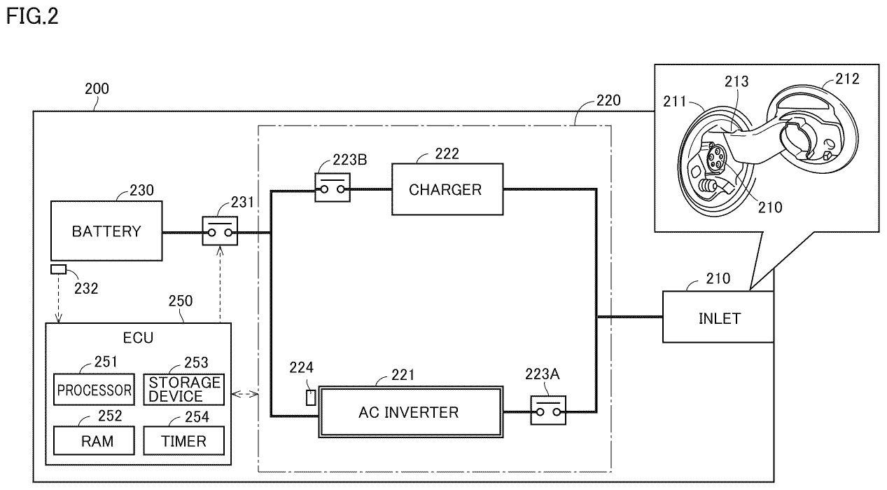

FIG. 2 is a diagram for illustrating a configuration around charging/discharging device 220. An SMR (system main relay) 231 is provided between charging/discharging device 220 and battery 230. SMR 231 is configured to switch connection/disconnection of an electrical path interconnecting charging/discharging device 220 and battery 230. When inlet 210 and battery 230 communicate power therebetween, ECU 250 closes (or connects) SMR 231. Battery 230 is provided with a BMS (a battery management system) 232. BMS 232 includes a variety of types of sensors to detect a state of battery 230, and outputs a detection result to ECU 250. ECU 250 can obtain the state of battery 230 (e.g., temperature, current, voltage, state of charge (SOC), etc. thereof) based on the output of BMS 232.

Inlet 210 is disposed in an opening 211 provided in the vehicular body. A lid 212 is attached to the vehicular body via a hinge 213. Inlet 210 is used with lid 212 opened. When lid 212 is closed, lid 212 covers opening 211 (including inlet 210) and thus prohibits use of inlet 210. Inlet 210 of the present embodiment is an AC inlet. When battery 230 is charged using inlet 210, AC power is input to inlet 210 from outside the vehicle.

ECU 250 is configured to control charging/discharging device 220. ECU 250 may be a computer. ECU 250 includes a processor 251, a random access memory (RAM) 252, a storage device 253, and a timer 254. ECU 250 corresponds to an example of a “power supply controller” and a “controller” according to the present disclosure. In ECU 250, processor 251 executes a program stored in storage device 253, and thereby vehicle 200 is controlled in a variety of manners. ECU 250 may include any number of processors, and each predetermined control may be applied through a processor prepared therefor.

Charging/discharging device 220 includes an AC inverter 221 and a charger 222 located between inlet 210 and battery 230 and connected in parallel. A discharging relay 223A is provided between AC inverter 221 and inlet 210. Discharging relay 223A is configured to switch connection/disconnection of a discharging path from AC inverter 221 to inlet 210. AC inverter 221 may include a plurality of inverters and an isolation circuit (an isolation transformer), for example, and receives DC power input from battery 230, converts the received DC power to AC power of a predetermined frequency, and outputs the AC power toward inlet 210. AC inverter 221 corresponds to an example of a “discharging device”of the present disclosure.

AC inverter 221 is provided with a monitoring unit 224. Monitoring unit 224 includes a variety of types of sensors to detect a state of AC inverter 221 (e.g., voltage, current, and temperature thereof), and outputs a detection result to ECU 250. ECU 250 controls AC inverter 221 based on the output of monitoring unit 224. This adjusts power output from AC inverter 221 to inlet 210 (or power supplied). AC inverter 221 outputs AC power, which is changed by a power supply voltage that discharging connector 100 (the discharging assembly) requires, and it may for example be a single-phase of 120V and may be AC power of 240 V of a single-phase three-wire system. ECU 250 may be configured to monitor a current of AC inverter 221 and limit the current for an inverter with a current likely to exceed a predetermined allowable value for the current.

ECU 250 can disconnect AC inverter 221 from inlet 210 by interrupting discharging relay 223A. Discharging relay 223A interrupted prohibits discharging power from AC inverter 221 to inlet 210.

Charger 222 receives AC power input from inlet 210, converts the received AC power to DC power, and outputs the DC power to battery 230. A charging relay 223B is provided between charger 222 and battery 230 (on a side closer to charger 222 than SMR 231 is). Charging relay 223B is configured to switch connection/disconnection of a charging path from charger 222 to battery 230. Charging relay 223B interrupted prohibits supplying power from inlet 210 to battery 230 via charger 222.

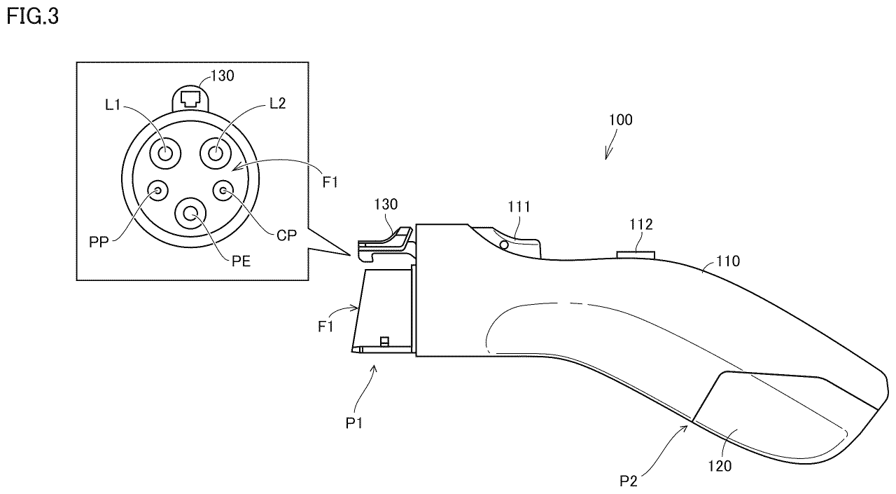

FIG. 3 is an external appearance of discharging connector 100. Discharging connector 100 has a first end P1 and a second end P2. First and second ends P1 and P2 are located at opposite ends of a main body 110 of discharging connector 100. First end P1 is configured to be connectable to inlet 210 of vehicle 200. Second end P2 includes socket To (see FIG. 1) to which plug 321 (see FIG. 1) of power cord 320 is connectable. Second end P2 of discharging connector 100 includes a cover 120 attached to be openable and closable. When cover 120 is opened, socket To provided at second end P2 is exposed, and plug 321 can be connected to the socket.

First end P1 of discharging connector 100 has an end surface F1 with a connector terminal. End surface F1 of first end P1 of discharging connector 100 is a surface (a connection surface) connected to inlet 210 of vehicle 200 (see FIG. 2). The connector terminal provided in end surface F1 includes an L1 terminal, an L2 terminal, a PE terminal, a PP terminal, and a CP terminal.

The L1 and L2 terminals correspond to two terminals to receive AC power from vehicle 200. Terminal L1 is a hot-side terminal, and terminal L2 is a cold-side terminal. Hereinafter, the L1 terminal will also be referred to as “AC1”, and the L2 terminal will also be referred to as “AC2”. The PE terminal corresponds to a ground terminal (hereinafter also referred to as “GND”). The PP terminal is a terminal (hereinafter also referred to as “PISW”) for detecting a state of discharging connector 100 and inlet 210 (that is, connected state/fitted state/unfitted state) (i.e., proximity detection). Hereinafter, a state of discharging connector 100 and inlet 210 will also be referred to as a “connector state”. The PP terminal outputs a potential signal (a PISW signal) indicating a connector state toward vehicle 200. Note that a potential of the PISW signal may be referred to as a “PISW potential”. The CP terminal corresponds to a terminal for a CPLT signal (hereinafter also referred to as “CPLT”) defined in the standard “IEC/TS 62763:2013”, for example. The CPLT signal is a PWM signal used in communications between vehicle 200 and discharging connector 100. The PISW signal corresponds to an example of a “first signal” of the present disclosure. The CPLT signal corresponds to an example of a “second signal” of the present disclosure.

Inlet 210 (FIG. 1) has terminals corresponding to the terminals of discharging connector 100 (L1, L2, PE, PP, CP). Hereinafter, in order to clarify the correspondence between the terminals on both sides, the terminals of inlet 210 corresponding to the L1, L2, PE, PP and CP terminals of discharging connector 100 will also be referred to as AC1, AC2, GND, PISW, and CPLT, respectively. The PISW of inlet 210 (corresponding to the PP terminal) corresponds to an example of a “first terminal” of the present disclosure. The CPLT of inlet 210 (corresponding to the CP terminal) corresponds to an example of a “second terminal”of the present disclosure.

When discharging connector 100 and inlet 210 are fitted together, the AC1, AC2, GND, PISW, and CPLT provided at first end P1 of discharging connector 100 come into contact with the AC1, AC2, GND, PISW, and CPLT, respectively, of inlet 210. Inlet 210 has the PISW configured to output to ECU 250 (FIG. 2) a potential signal (a PISW potential) indicating information of the discharging assembly (the discharging connector) connected to inlet 210. The information of the discharging assembly includes a value of voltage that the discharging assembly requires, an upper limit current (a maximum current), and a type of a socket that the discharging assembly includes. Thus, ECU 250 is configured to obtain the value of voltage that the discharging assembly connected to inlet 210 requires and the like, and the type of the socket that the discharging assembly connected to inlet 210 includes. Discharging connector 100 may have a terminal and a structure to fit to inlet 210 in conformity with Type 1 defined in the standard “SAEJ1772/IEC62196-2”, for example.

Discharging connector 100 further includes an unlatch button 111, a start discharge switch 112, and a latch 130.

Unlatch button 111 has a function of unlatching discharging connector 100 from inlet 210 and a function of causing vehicle 200 (for example, ECU 250) to sense a connector state (i.e., connected state/fitted state/unfitted state). Latch 130 is configured to engage with inlet 210 to secure (or latch) discharging connector 100 to inlet 210.

For example, discharging connector 100 is latched when latch 130 has a tip thereof hooked to a recess formed in inlet 210. Latch 130 gangs with unlatch button 111. When the user presses unlatch button 111, the latch is disengaged.

When the user inserts discharging connector 100 into inlet 210 without pressing unlatch button 111 and fits discharging connector 100 to inlet 210, discharging connector 100 and inlet 210 are secured by latch 130 while they are electrically connected together. This connector state is a “connected state”. In the connected state, discharging connector 100 is inserted into inlet 210, they have their terminals all electrically connected, and discharging connector 100 is latched. When the user presses unlatch button 111 in the connected state, latch 130 no longer secures the discharging connector to the inlet. This connector state is a “fitted state”. In the fitted state, discharging connector 100 is inserted into inlet 210, they have their terminals all electrically connected, and discharging connector 100 is unlatched. When the user pulls out discharging connector 100 from inlet 210 in the fitted state, the connector state becomes an “unfitted state”. The unfitted state is a state which is neither the connected state nor the fitted state. When the connector state is the connected state or the fitted state, ECU 250 prohibits vehicle 200 from travelling.

Start discharge switch 112 has a function of causing vehicle 200 (for example, ECU 250) to sense that discharging power starts by changing the PISW signal (or the PISW potential). The PISW signal will more specifically be described hereinafter.

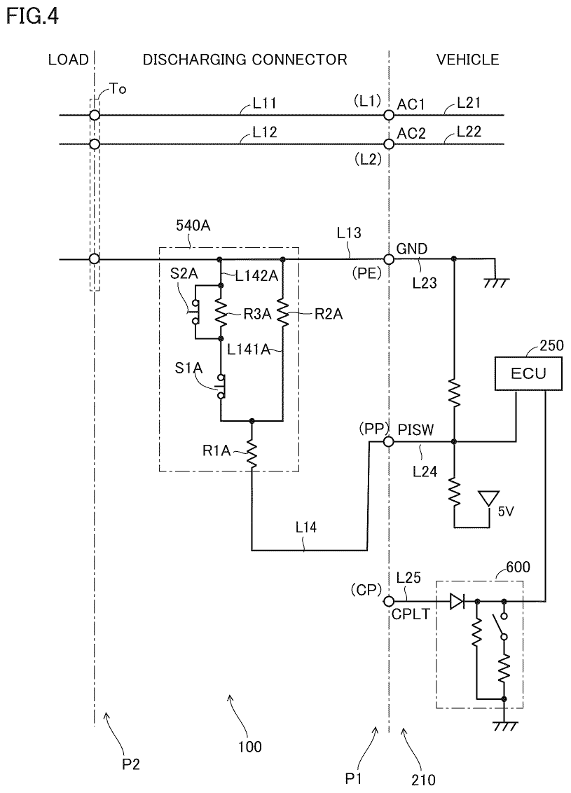

FIG. 4 shows a schematic circuit configuration of discharging connector 100 and inlet 210 in a power supply system using the PISW signal. In FIG. 4, discharging connector 100 employs a power supply system using the PISW signal. Discharging connector 100 has a voltage line L11, a voltage line L12, and a neutral line L13 connected to first end P1's AC1, AC2, and GND, respectively. Vehicle 200 has a voltage line L21, a voltage line L22, and a neutral line L23 connected to inlet 210's AC1, AC2, and GND, respectively. Voltage lines L21 and L22 transmit AC power output from AC inverter 221. The voltage of the AC power output from AC inverter 221 is changed by a power supply voltage that discharging connector 100 (or the discharging assembly) requires.

In vehicle 200, a reference voltage is provided between the vehicular body (or the ground) and a signal line L24, and signal line L24 is connected to the PISW. The PISW signal (or PISW potential) is input to ECU 250 via signal line L24. When discharging connector 100 (first end P1) is electrically connected to inlet 210, the PP terminal of discharging connector 100 receives the reference voltage supplied from vehicle 200. A closed circuit (hereinafter also referred to as a “first PISW circuit”) is formed so that the PISW and the GND are connected via a detection circuit 540A (described hereinafter) of discharging connector 100. Thus, the PISW varies in potential, and a PISW signal is generated. ECU 250 can determine a connector state based on the PISW signal (or PISW potential).

In vehicle 200, the CP terminal (CPLT) is connected to ECU 250 via a signal line L25. Signal line L25 is provided with a CPLT circuit 600. CPLT circuit 600 includes a switch controlled by ECU 250. The CPLT signal is not used in discharging connector 100.

Detection circuit 540A includes electrical resistors R1A, R2A and R3A, and switches S1A and S2A. A signal line L14 branches from the PISW via electrical resistor R1A into two branch paths L141A and L142A. Branch paths L141A and L142A are connected to neutral line L13. Electrical resistor R2A is disposed on branch path L141A, and electrical resistor R3A and switch S1A are disposed on branch path L142A. Electrical resistors R2A and R3A are disposed in parallel. Electrical resistor R3A and switch S1A are disposed in series. Switch S2A is disposed in parallel to electrical resistor R3A. Detection circuit 540A corresponds to an example of a “resistance circuit”of the present disclosure.

Switch S1A gangs with unlatch button 111 (FIG. 3) of discharging connector 100 to open and close. Switch S1A is closed (or conducts) when unlatch button 111 is not pressed, and the switch is open (or interrupted) when unlatch button 111 is pressed. Switch S2A gangs with start discharge switch 112 (FIG. 3) of discharging connector 100 to open and close. Switch S2A is closed (or conducts) when start discharge switch 112 is turned off, and the switch is open (or interrupted) when start discharge switch 112 is turned on. In the present embodiment, start discharge switch 112 is turned on while the user presses start discharge switch 112, and start discharge switch 112 is turned off when the user releases start discharge switch 112. When the user does not operate any of unlatch button 111 and start discharge switch 112, switches S1A and S2A are all closed. Switches S1A and S2A each correspond to a normally-on switch.

Unlatch button 111 functions as a switch to stop discharging power from vehicle 200. Start discharge switch 112 functions as a switch to start discharging power from vehicle 200. When the user operates start discharge switch 112, as predetermined, while the connector state is the connected state, vehicle 200 (ECU 250) recognizes that discharging power starts, and the vehicle (the ECU) starts discharging power. In the present embodiment, discharging power is started when the user turns on start discharge switch 112 twice. When unlatch button 111 is pressed while the vehicle discharges power, and the connector state becomes the fitted state or the unfitted state, vehicle 200 (ECU 250) recognizes that discharging power stops, and the vehicle (the ECU) stops discharging power.

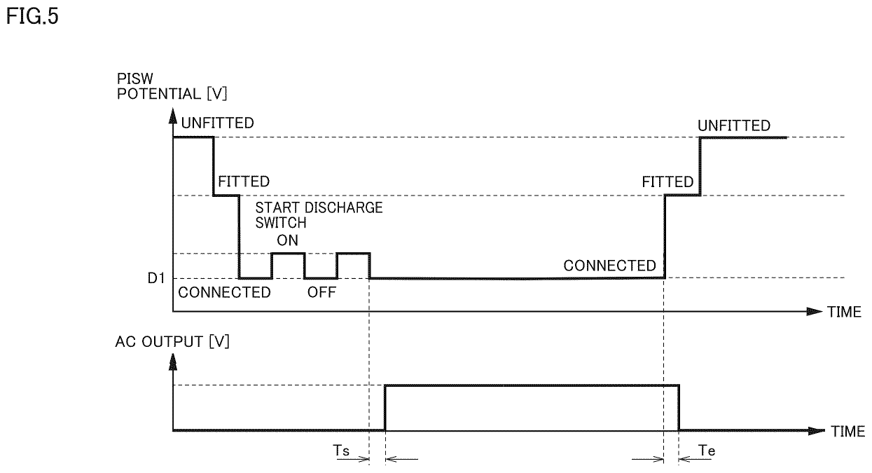

FIG. 5 is timing plots representing a sequence of starting and stopping discharging power by discharging connector 100 in the power supply system using the PISW signal. In FIG. 5, the top plot represents the PISW potential (or PISW signal), the middle plot represents power discharged output (or AC output), and the bottom plot represents the PWM signal. When the user inserts discharging connector 100 into inlet 210 while pressing unlatch button 111 the connector state is changed from the unfitted state to the fitted state. When the connector state is the fitted state, discharging connector 100 and inlet 210 are electrically connected together, and the PISW and the GND are connected via detection circuit 540A. Thus, the first PISW circuit is formed by detection circuit 540A, and the PISW decreases in potential. Thereafter when the user releases unlatch button 111 the connector state changes from the fitted state to the connected state and the PISW further decreases in potential.

In the connected state the PISW has a potential D1, which can be set, as appropriate, according to values of electrical resistors R1A, R2A and R3A. The PISW potential D1 is set based on at least one of a power supply voltage and a maximum current (or an upper limit current) that discharging connector 100 requires. In the present embodiment, the PISW potential D1 includes information of both the power supply voltage and the maximum current. For the PISW potential D1, for example, three patterns of “120 V:12 A”, “120 V:24 A”, and “240 V:32 A” may be set. Based on the PISW potential D1, ECU 250 sets discharged power (or supplied power) to be a power supply voltage and a maximum current that discharging connector 100 requires.

The connector state becomes the connected state, and thereafter when a predetermined period of time (e.g., of 500 ms) elapses, operation of start discharge switch 112 is enabled. When the user turns on start discharge switch 112, the PISW rises in potential. Thereafter when the user turns start discharge switch 112 back to off the PISW potential also turns back. When the user operates start discharge switch 112 to turn it on, off, on, off while the connector state is the connected state, ECU 250 recognizes that discharging power starts based on the PISW potential, and the ECU starts discharging power. In order to suppress an erroneous operation caused by noise, the recognition of start discharge switch 112 by ECU 250 is effective when a voltage corresponding to the on/off operation continues for a predetermined period of time (for example of 50 ms to 3000 ms).

Vehicle 200 discharges power as controlled by ECU 250. ECU 250 controls charging/discharging device 220 (AC inverter 221) so that discharged power set by the PISW potential D1 is output from inlet 210 to discharging connector 100. Furthermore, while the vehicle discharges power, SMR 231 (FIG. 2) is controlled to be closed. A period of time Ts after an operation to start discharging power is performed before discharging power starts can be set as desired. ECU 250 may perform a predetermined process (e.g., a pre-discharging inspection such as inspection for disconnection) during the period of time Ts. During the period of time Ts, SMR 231 may be switched from an open state to a closed state. When unlatch button 111 is pressed while the vehicle discharges power, the connector state changes from the connected state to the fitted state and the PISW rises in potential. When the connector state becomes the fitted state, ECU 250 recognizes that discharging power stops based on the potential of the PISW, and the ECU stops discharging power. A period of time Te after an operation to stop discharging power is performed before discharging power is stopped may be a period of time defined in the standard “IEC61851-1”.

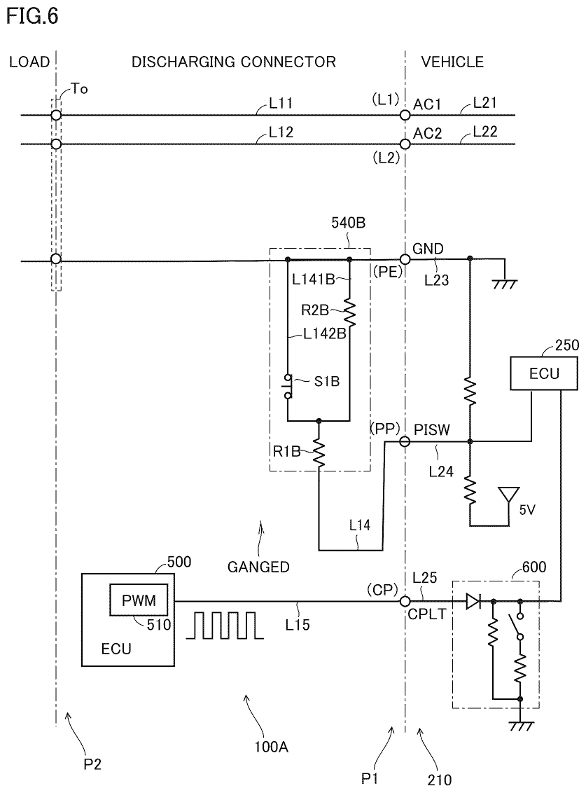

FIG. 6 shows a schematic circuit configuration of a discharging connector 100A and inlet 210 in a power supply system using the CPLT signal. Discharging connector 100A has a circuit configuration different from that of discharging connector 100.

Discharging connector 100A has a remainder in configuration similar to that of discharging connector 100 except that the former excludes start discharge switch 112. When discharging connector 100A is connected to inlet 210, a closed circuit (hereinafter also referred to as a “second PISW circuit”) is formed so that the PISW and the GND are connected via a detection circuit 540B of discharging connector 100A. Thus, the PISW varies in potential, and a PISW signal is generated. ECU 250 can determine a connector state based on the PISW signal (or PISW potential).

Detection circuit 540B includes electrical resistors R1B and R2B and a switch S1B. Signal line L14 branches from the PISW via electrical resistor R1B into two branch paths L141B and L142B. Branch paths L141B and L142B are connected to neutral line L13. Electrical resistor R2B is disposed on branch path L141B, and switch S1B is disposed on branch path L142B. Detection circuit 540B corresponds to an example of the “resistance circuit”of the present disclosure.

Switch S1B gangs with unlatch button 111 (FIG. 3) of discharging connector 100 to open and close. Switch S1B is closed (or conducts) when unlatch button 111 is not pressed, and the switch is open (or interrupted) when unlatch button 111 is pressed. Switch S1B corresponds to a normally-on switch.

ECU 500 includes a CPLT signal generator 510. PWM signal generator 510 is connected to the CP terminal (CPLT) of discharging connector 100 by a signal line L15. CPLT signal generator 510 generates a PWM signal (a CPLT signal), which is transmitted on signal line L15. In vehicle 200, the CPLT is connected to ECU 250 via signal line L25. Signal line L25 is provided with CPLT circuit 600. CPLT circuit 600 includes a switch controlled by ECU 250. ECU 250 can transmit to ECU 500 a CPLT signal generated by CPLT circuit 600. Electrically connecting ECU 500 to the CPLT allows ECU 500 and ECU 250 to communicate data (CPLT) therebetween.

Discharging connector 100A also has its connector state changed from the unfitted state to the fitted state when the user inserts discharging connector 100A into inlet 210 while pressing unlatch button 111. When the connector state is the fitted state, discharging connector 100A and inlet 210 are electrically connected together, and the PISW and the GND are connected via detection circuit 540B. Thus, the second PISW circuit is formed by detection circuit 540B, and the PISW decreases in potential. Thereafter when the user releases unlatch button 111 the connector state changes from the fitted state to the connected state and the PISW further decreases in potential. When discharging connector 100A is in the connected state, the PISW has a potential set within a range different from a range in which the PISW potential D1 for discharging connector 100 is set. For example, the PISW potential for discharging connector 100A is set to a potential indicating that the connector is a connector for discharging (or supplying) power, and this PISW potential does not include information of a power supply voltage or a maximum current (or upper limit current) that discharging connector 100A requires. Based on the PISW potential, ECU 250 detects that the connector connected to inlet 210 is not a charging connector and instead a discharging connector.

When ECU 250 detects that discharging connector 100A is connected to inlet 210 as the PISW potential decreases, the ECU connects the switch of CPLT circuit 600. Then, signal line L15 decreases in potential. When signal line L15 decreases in potential, ECU 500 operates PWM signal generator 510 to generate a PWM signal (a CPLT signal). The PWM signal includes information of at least one of a power supply voltage and a maximum current (or upper limit current) that discharging connector 100A requires. For example, when the power supply voltage and the maximum current are set depending on the PWM signal's duty ratio, potential, etc., the power supply voltage and the power supply current can be set in more patterns than the PISW signal (the potential D1). For example, patterns such as “120V:12A”, “120V:24A”, “120V:30A”, “240V:32A”, “240V:50A”, and “240V:80A” may be set. Thus, the PWM signal (the CPLT signal) is transmitted to ECU 250. Based on the PWM signal, ECU 250 detects the power supply voltage and the like that discharging connector 100A requires, and the ECU sets power discharged (or supplied) when discharging the power is started to be the power supply voltage and maximum current that discharging connector 100A requires. When preparation for discharging power is completed, ECU 250 controls charging/discharging device 220 (AC inverter 221) so that discharged power set by the PISW signal is output from inlet 210 to discharging connector 100A.

Thus, when discharging connector 100 is connected to inlet 210, supplying (or discharging) power is started so that discharged power set by the PISW potential D1 is output from inlet 210 to discharging connector 100. When discharging connector 100A is connected to inlet 210, supplying (or discharging) power is started so that discharged power set by the PWM signal is output from inlet 210 to discharging connector 100A.

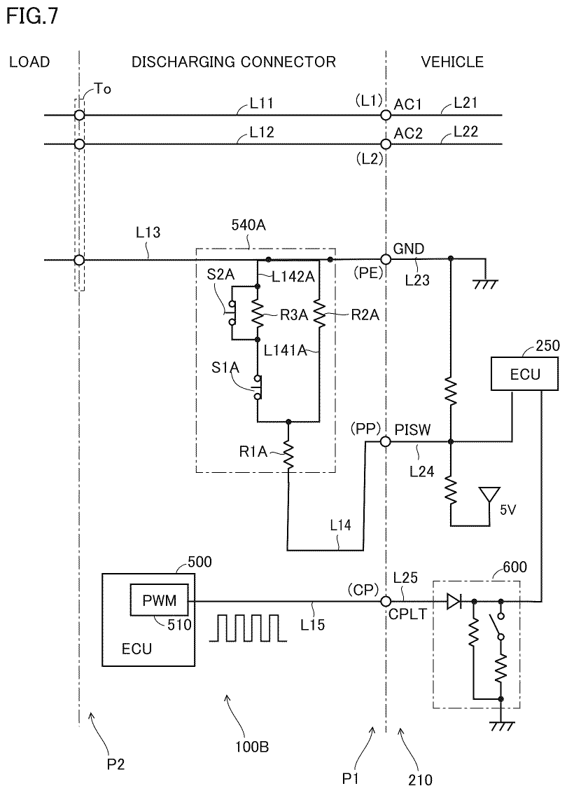

FIG. 7 shows a schematic circuit configuration of a third discharging connector 100B and inlet 210. Discharging connector 100B has a circuit configuration different from that of discharging connector 100. Discharging connector 100B has a remainder in configuration similar to that of discharging connector 100. Third discharging connector 100B includes detection circuit 540A similar to that of discharging connector 100, and ECU 500 including PWM signal generator 510. ECU 500 (PWM signal generator 510) may be similar to ECU 500 (PWM signal generator 510) of discharging connector 100A. When discharging connector 100B is connected to inlet 210, the PISW and the GND are connected via detection circuit 540A to form the first PISW circuit. Thus, signal line L15 and signal line L25 are connected by the CPLT, and ECU 250 and ECU 500 can communicate data.

Discharging connector 100B is similar to discharging connector 100 in that when the connector state is the connected state the PISW decreases in potential to the PISW potential D1. The PISW potential D1 includes information of a power supply voltage and a maximum current, and ECU 250 sets discharged (or supplied) power based on the PISW potential D1 to be a power supply voltage and a maximum current that discharging connector 100B requires.

When the connector state of discharging connector 100B becomes the connected state, the PISW potential decreases. When ECU 250 detects that discharging connector 100B is connected to inlet 210 as the PISW potential decreases, the ECU connects the switch of CPLT circuit 600. Then, signal line L15 decreases in potential. When signal line L15 decreases in potential, ECU 500 operates PWM signal generator 510 to generate a PWM signal (a CPLT signal). Based on the PWM signal, ECU 250 detects a power supply voltage and the like that discharging connector 100B requires, and the ECU sets power discharged (or supplied) when discharging the power is started to be the power supply voltage and maximum current that the PWM signal requires.

Thus, when discharging connector 100B is connected to inlet 210, it is expected that a power supply voltage and a maximum current based on the PISW potential D1 and a power supply voltage and a maximum current based on the PWM signal are set simultaneously. When the power supply voltage and maximum current based on the PISW potential D1 and the power supply voltage and maximum current based on the PWM signal are different, an overvoltage or an overcurrent may be generated in supplied power.

Note that for discharging connector 100A as well, depending on the values of electrical resistors R1B and R2B of detection circuit 540A, a potential that the PISW has when the connector state is the connected state may overlap the set range of the PISW potential D1. In this case as well, when discharging connector 100A is connected to inlet 210, as well as when discharging connector 100B is connected to the inlet, the power supply voltage and maximum current based on the PISW potential D1 and the power supply voltage and maximum current based on the PWM signal can be set simultaneously. When the power supply voltage and maximum current based on the PISW potential D1 and the power supply voltage and maximum current based on the PWM signal are different, an overvoltage or an overcurrent may be generated in supplied power.

In the present embodiment, when the power supply voltage and maximum current based on the PISW potential D1 and the power supply voltage and maximum current based on the PWM signal are set simultaneously, the lower power supply voltage and the smaller maximum current are applied to discharge (or supply) power to suppress overvoltage or overcurrent.

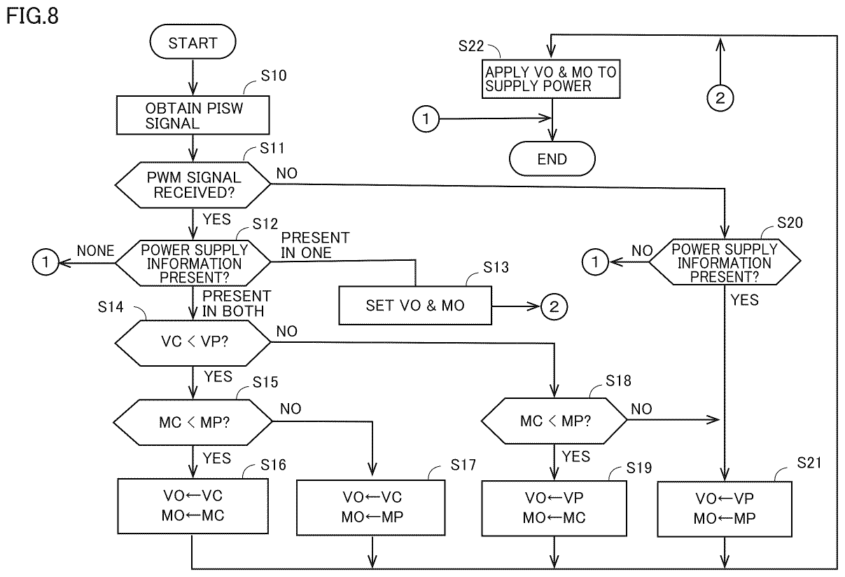

FIG. 8 is a flowchart of an example of a process performed by ECU 250 to start discharging power. This flowchart is executed when discharging connectors 100 to 100B are connected to inlet 210 (or when the connector state is the fitted state) while vehicle 200 is stationary. For example, the process may be started when the connector state is the fitted state and the PISW potential decreases.

In step (hereinafter, abbreviated as “S”) 10, ECU 250 senses from a PISW signal (or PISW potential) that the connector state is the connected state, and the ECU stores the PISW potential.

Subsequently, in S11, ECU 250 determines whether a PWM signal is received from the discharging connector. When the discharging connector connected to inlet 210 does not include PWM signal generator 510 (for example, when discharging connector 100 is connected), ECU 250 does not receive the PWM signal, and accordingly, a negative determination is made and the process proceeds to S20. When the PWM signal is received, a positive determination is made and the process proceeds to S12.

In S12, ECU 250 determines whether at least one of the PISW signal and the PWM signal includes power supply information. When the PISW signal obtained in S10 has a potential within the set range of the PISW potential D1, it is determined that the PISW signal includes the power supply information. Furthermore, when the PWM signal has a duty ratio within a predetermined range in which the power supply information is set, it is determined that the PWM signal includes the power supply information.

In S12, when neither the PISW signal nor the PWM signal includes the power supply information, it is determined that the connector connected to inlet 210 is a charging connector (a decision of “none”is made), and the current routine is ended.

In S12, when the PISW signal obtained in S10 has a potential within the set range of the PISW potential D1, ECU 250 sets from that potential a power supply voltage and a maximum current based on the PISW signal (hereinafter also referred to as a “power supply voltage VP” and a “maximum current MP”, respectively). When the PWM signal has a duty ratio including the power supply information, ECU 250 sets a power supply voltage and a maximum current based on the duty ratio or the like (hereinafter also referred to as a “power supply voltage VC” and a “maximum current MC”, respectively).

In S12, when one of the PISW signal and the PWM signal includes the power supply information (“present in one”), the process proceeds to S13, whereas when the PISW signal and the PWM signal both include the power supply information (“present in both”), the process proceeds to S14.

In S13, the power supply voltage and maximum current set based on the power supply information are set for a discharging voltage VO and a discharging current MO, and the process proceeds to S22. When the PISW signal includes the power supply information, the power supply voltage VP is set for the discharging voltage VO (VO←VP), and the maximum current MP is set for the discharging current MO (MO←MP). When the PWM signal includes the power supply information, the power supply voltage VC is set for the discharging voltage VO (VO←VC), and the maximum current MC is set for the discharging current MO (MO←MC).

In S14, whether the power supply voltage VC is lower than the power supply voltage VP is determined. When the power supply voltage VC is lower than the power supply voltage VP, a positive determination is made and the process proceeds to S15. When the power supply voltage VC is equal to or higher than the power supply voltage VP, a negative determination is made, and the process proceeds to S18.

In S15, whether the maximum current MC is smaller than the maximum current MP is determined. When the maximum current MC is smaller than the maximum current MP, a positive determination is made and the process proceeds to S16. When the maximum current MC is equal to or larger than the maximum current MP, a negative determination is made and the process proceeds to S17.

In S16, the power supply voltage VC is set for the discharging voltage VO (VO←VC), and the maximum current MC is set for the discharging current MO (MO←MC), and the process proceeds to S22. In S17, the power supply voltage VC is set for the discharging voltage VO (VO←VC), and the maximum current MP is set for the discharging current MO (MO←MP), and the process proceeds to S22.

In S18, whether the maximum current MC is smaller than the maximum current MP is determined. When the maximum current MC is smaller than the maximum current MP, a positive determination is made and the process proceeds to S19. When the maximum current MC is equal to or larger than the maximum current MP, a negative determination is made and the process proceeds to S21.

In S19, the power supply voltage VP is set for the discharging voltage VO (VO←VP), and the maximum current MC is set for the discharging current MO (MO←MC), and the process proceeds to S22.

In S20, ECU 250 determines whether the PISW signal includes the power supply information. When the PISW signal obtained in S10 has a potential within the set range of the PISW potential D1, it is determined that the PISW signal includes the power supply information. When the PISW signal does not include the power supply information, it is determined that the connector connected to inlet 210 is a charging connector, and the current routine ends.

When it is determined in S20 that the PISW signal includes the power supply information, that is, when the PISW signal has a potential within the set range of the PISW potential D1, the process proceeds to S21, and the power supply voltage VP and the maximum current MP are set based on that potential.

In S21, the power supply voltage VP is set for the discharging voltage VO (VO←VP) and the maximum current MP is set for the discharging current MO (MO←MP), and the process proceeds to S22.

In S22, when preparation is completed for discharging power, ECU 250 controls AC inverter 221 so that discharged power is the discharging voltage VO and the discharging current MO, and the ECU starts supplying power. Note that the discharging current MO is an upper limit value for a current output from AC inverter 221.

According to the present embodiment, power of battery 230 mounted on vehicle 200 is converted to AC power by charging/discharging device 220 (AC inverter 221) and supplied to electrical load 300 through discharging connectors 100 to 100B constituting a discharging assembly. When discharging connectors 100 to 100B are connected to inlet 210 and ECU 250 receives via the PP terminal of inlet 210 (PISW) a PISW signal indicating a voltage the ECU sets a power supply voltage VP based on the PISW signal, and when the ECU receives a PWM signal via the CP terminal of inlet 210 (CPLT) the ECU sets a power supply voltage VC based on the PWM signal (“present in both” in S12). When the power supply voltage VP is set and the power supply voltage VC is also set, ECU 250 applies the lower one of the power supply voltage VP and the power supply voltage VC to cause vehicle 200 to externally supply power (S14 to S19, S21, and S22). Thus, in the present embodiment, even when the power supply voltage VP and the power supply voltage VC are both set, the lower voltage is applied to supply (or discharge) power, and this can supply (or discharge) power without generating overvoltage.

According to the present embodiment, when the PISW signal includes information of the maximum current MP and the PWM signal includes information of the maximum current MC, and the power supply voltage VP is set and the power supply voltage VC is also set, ECU 250 applies the smaller one of the maximum current MP and the maximum current MC to cause the vehicle to externally supply power (S14 to S19, S21, and S22). This allows vehicle 200 to supply (or discharge) power while suppressing generation of overcurrent.

According to the present embodiment, when the power supply voltage VP based on the PISW signal is alone set, ECU 250 applies the power supply voltage VP to discharge power (S13, S20 with positive decision, and S21). When the power supply voltage VC based on the PWM signal is alone set, ECU 250 applies the power supply voltage VC to discharge power (S13). Therefore, when discharging connector 100 of a power supply system using the PISW signal or discharging connector 100A of a power supply system using the CPLT signal is connected to inlet 210, suitable power supply can be performed.

According to the present embodiment, ECU 250 detects that a discharging connector is connected to inlet 210 based on a potential of the PISW signal. Therefore, whichever one of discharging connectors 100 to 100B a discharging connector connected to inlet 210 may be, the ECU can detect that a discharging connector is connected.

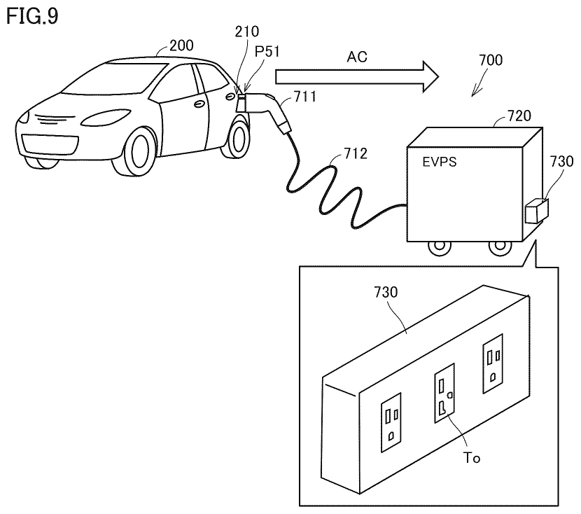

In the above embodiment, the discharging connector alone functions as a discharging assembly (or power supply equipment). However, it is not essential that the discharging assembly is constituted of a discharging connector alone. FIG. 9 shows a modification of the discharging assembly (or discharging connector).

Referring to FIG. 9, a discharging assembly 700 includes a discharging connector 711, a housing 720 incorporating a circuit electrically connected to discharging connector 711, and a cable 712 connecting discharging connector 711 and housing 720. Housing 720 corresponds to a main body of an EVPS (electric vehicle power system). The EVPS is configured to control charging/discharging power to/from a vehicle. Housing 720 may include a display, a console, and the like. Discharging assembly 700 includes the EVPS and a charging/discharging cable assembly. The charging/discharging cable assembly is a cable assembly for coupling the vehicle and the EVPS and includes a charging/discharging connector for coupling to the vehicle. In the example shown in FIG. 9, discharging connector 711 functions as a charging/discharging connector. Cable 712 functions as a charging/discharging cable.

Discharging connector 711 is configured to be connectable to inlet 210 of vehicle 200. Housing 720 includes a socket box 730. Socket box 730 for example has a plurality of sockets To. In this modification, the circuit shown in any of FIG. 4, 6 or 7 (the circuit of any of discharging connectors 100 to 100B) is provided inside discharging connector 711, cable 712, and housing 720.

For discharging assembly 700 according to this modification, discharging connector 711 and housing 720 are connected via cable 712, and a degree of freedom in disposing socket To is increased. Furthermore, a portion of a discharging circuit can be accommodated in housing 720, and discharging connector 711 can be easily reduced in size.

In the above embodiment, a discharging assembly is used to supply (or discharge) to electrical load 300 the power of battery 230 mounted on vehicle 200. However, the discharging assembly may be used to supply (or discharge) to an external load the power generated by a power generation device mounted on a vehicle. For example, the vehicle may be an FCEV (fuel cell electric vehicle) having a hydrogen tank and a fuel cell mounted thereon.

While embodiments of the present disclosure have been described above, it should be understood that the embodiments disclosed herein are by way of illustration and example only and not to be taken by way of limitation. The scope of the present disclosure is interpreted by the terms of the appended claims and is intended to encompass any modification falling within the meaning and scope equivalent to the terms of the claims.

What is claimed is:

1. A power supply controller that causes a vehicle to supply power to an outside of the vehicle, the vehicle having at least one of a power storage device and a power generation device mounted thereon, the power supply controller being configured to:
when a discharging connector is connected to a discharging port of the vehicle, and a first signal is received through a first terminal of the discharging port, apply a first power supply voltage based on the first signal to start supplying power;
when the discharging connector is connected to the discharging port, and a second signal is received through a second terminal of the discharging port, apply a second power supply voltage based on the second signal to start supplying power; and
when the first and second signals are both received, apply a lower one of the first and second power supply voltages to cause the vehicle to supply power to the outside.

2. The power supply controller according to claim 1, wherein
the first signal includes information of a first maximum current,
the second signal includes information of a second maximum current, and
when the first and second signals are both received, the power supply controller applies a smaller one of the first and second maximum currents to cause the vehicle to supply power to the outside.

3. The power supply controller according to claim 1, wherein
when the discharging connector is connected to the discharging port, the first terminal forms a closed circuit with a resistance circuit provided on a side of the discharging connector,
the first signal is a potential signal coming from the resistance circuit, and
the second signal is a PWM signal transmitted from the side of the discharging connector.

4. The power supply controller according to claim 3, wherein
when the discharging connector is connected to the discharging port, the first signal decreases in potential, and
the power supply controller detects from the potential of the first signal that the discharging connector is connected to the discharging port.

5. A vehicle having at least one of a power storage device and a power generation device mounted thereon, the vehicle comprising:
a discharging port;
a discharging device provided between the discharging port and at least one of the power storage device and the power generation device; and
a controller configured to control the discharging device, the controller being configured to:
when a discharging connector is connected to the discharging port, and a first signal received through a first terminal of the discharging port indicates a voltage, set a first power supply voltage based on the first signal;
when the discharging connector is connected to the discharging port, and a second signal is received through a second terminal of the discharging port, set a second power supply voltage based on the second signal; and
when the first power supply voltage is set and the second power supply voltage is also set, control the discharging device so that the discharging device applies a lower one of the first and second power supply voltages to start discharging power from the discharging device.

6. The vehicle according to claim 5, wherein
the first signal includes information of a first maximum current,
the second signal includes information of a second maximum current, and
when the first power supply voltage is set and the second power supply voltage is also set, the controller is configured to control the discharging device so that the discharging device applies a smaller one of the first and second maximum currents to start discharging power from the discharging device.

7. The vehicle according to claim 5, wherein the discharging device converts direct-current power of the power storage device or the power generation device to an alternating-current power.
